(19) United States
(12) Patent Application Publication
(10) Pub. No.: US 2008/0212643 A1
(43) Pub. Date: Sep. 4, 2008

(54) TEMPERATURE MONITORING DEVICE

(76) Inventors: D. David McGahhey, Orange, CA (US); Richard A. Molina, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/041,605

(22) Filed: Mar. 3, 2008

Related U.S. Application Data
(60) Provisional application No. 60/892,822, filed on Mar. 2, 2007.

(51) Int. Cl. G01K 13/00

(52) U.S. Cl. 374/152; 236/51

(57) ABSTRACT

A wireless device monitors the temperature of a fluctuating thermal environment. The device may be contained within a thermal cycling machine. The device may comprise sensors, signal translators, an intelligent complex formula converter and protocol arbitration unit, portable power source, electromagnetic transmitter/receiver and antenna to receive various commands and to deliver the instantaneous temperature of various physical points to a control device located outside of the thermal cycling machine. The device is capable of monitoring the temperature fluctuations within a thermal cycler without the need to interfere with normal operation by a cable or wiring harness. In accordance with some embodiments of the present inventions, a temperature monitoring system is disclosed that includes a controller and a temperature monitoring device. The temperature monitoring device may include a core and a cartridge. The core includes a processor and a wireless transmitter. The cartridge includes one or more temperature sensors. The controller is configured to receive temperature data transmitted by the temperature monitoring device.

### RELATED APPLICATIONS

This application is related to, and claims the benefit of U.S. Provisional 60/892,822 filed Mar. 2, 2007, the entirety of which is hereby incorporated by reference herein and made a part of the present specification.

### BACKGROUND OF THE INVENTION

1. Technical Field

The present invention relates to remote temperature monitoring, including in certain embodiments, temperature monitoring in high heat environments. Certain embodiments of the invention relate to temperature monitoring in a thermal cycler.

2. Description of Related Technology

A thermal cycler (also known as a thermocycler, PCR machine or DNA amplifier) is a laboratory apparatus used for polymerase chain reaction or PCR. PCR is a biochemistry and molecular biology technique for enzymatically replicating DNA without using a living organism, such as E. coli or yeast.

Like amplification using living organisms, the PCR technique allows a small amount of DNA to be amplified exponentially. As PCR is an in vitro technique, it can be performed without restrictions on the form of DNA, and it can be extensively modified to perform a wide array of genetic manipulations. PCR is commonly used in medical and biological research labs for a variety of tasks, such as the detection of hereditary diseases, the identification of genetic fingerprints, the diagnosis of infectious diseases, mutagenesis, genotyping of specific mutations, gene cloning, paternity testing, and DNA computing.

PCR is used to amplify specific regions of a DNA strand. This can be a single gene, just a part of a gene, or a non-coded sequence. PCR typically amplifies only short DNA fragments, usually up to 10 kilo base pairs (kb). Certain methods can copy fragments up to 25 kb in size, which is still much less than the chromosomal DNA of a eukaryotic cell—for example, a human cell contains about three billion base pairs (3 Gbp).

The PCR process is carried out in a thermal cycler. This is a machine that heats and cools the reaction tubes within it to the precise temperature required for each step of the reaction. A typical thermal cycler has a thermal block with holes where tubes with the PCR reaction mixtures can be inserted. The cycler then raises and lowers the temperature of the block in discrete, pre-programmed steps. Modern thermal cyclers are often equipped with a hot bonnet, a heated plate that presses against the lids of the reaction tubes. This prevents condensation of water from the reaction mixtures to the insides of the lids and makes it unnecessary to use PCR oil which can be placed on the reaction mixture to prevent evaporation. There are various types and configurations of thermal cyclers. Some thermal cyclers are equipped with multiple blocks allowing several different PCR reactions to be carried out simultaneously. Also, some apparatuses have a gradient function, which allows different temperatures in different parts of the block. This gradient function is particularly useful when testing suitable annealing temperatures for primers.

Thus, thermal cycling machines are capable of providing the means to apply various amounts of heating or cooling energy within a contained thermal environment, allowing control of the temperature within a typical range of 0 to 110° C. A particular static temperature or a series of temperatures within the operating range relating to temperature and duration can be set by a user at will. Generally, small volumes of biological samples are placed inside the thermal cycling machine within small vessels to cause a reaction or a desired effect by changing the environmental temperature. Some thermal cycling machines are also capable of controlling a secondary heating plate to reduce undesirable vapors.

A different thermal cycling instrument is available from Idaho Technologies. This instrument employs forced-air heating and cooling of capillary sample carriers mounted in a carousel. The instrument monitors each capillary sample carrier in sequence as the capillary sample carriers are rotated past an optical detection site. Ambient air is drawn into the machine by a small fan and warmed with a heating coil. Since air has a very low thermal capacity, the instrument can attain a thermal ramping rate of about 20° C. per second. Thus, heating and cooling occurs about ten times faster than in a conventional thermal cycler. The PCR reaction occurs in glass capillaries placed in a sample carousel that rotates in the thermal chamber of the instrument.

Another instrument configuration is available from Cepheid and consists of a system that includes a reaction vessel for holding the sample and a heat-exchanging module into which the vessel is inserted for thermal processing and optical detection. The heat-exchanging module includes a pair of opposing plates between which the vessel is inserted for thermal processing, one or more heating or cooling elements for heating or cooling the plates, and optics for optically interrogating the sample contained in the vessel. The system also includes a base unit with processing electronics for receiving a plurality of such heat-exchanging modules and for independently controlling each module.

It is important to verify that the set point temperature of the thermal cycling machine corresponds to the actual temperature of the contained thermal environment within a certain tolerance. The thermal cycler manufacture will typically maintain a means to verify the temperature performance of their instrument as part of their quality systems, manufacturing process, or service offerings. In turn, a typical instrument end-user (e.g. laboratory technician or scientist) is often required to perform a temperature verification test of their thermal cycler instruments as part of their general quality program to comply with a variety of regulatory standards. The technician may wish to verify that each instrument is performing to the manufacturer's specifications. A thermal cycler is also tested to gain a better understanding of the instrument's temperature performance and thus ensure the chemistry formulas and test assays are optimized for each specific type or model instrument.

Several studies published in scientific literature provide a rationale for the increasing regulatory requirements to perform quality tests of laboratory instruments. The results of these studies provide compelling evidence that thermal cycler instrument performance testing should regularly be carried out and become a part of any laboratory accreditation program. It has been found that temperature performance can have a significant impact on a reaction. For example, reactions may occur at the intermediate temperatures, creating unwanted and interfering side products, such as PCR “primer-dimers” or anomalous amplicons, which are detrimental to the analytical process. Poor control of temperature also results in over-consumption of expensive reagents necessary for the intended reaction.

This verification can be accomplished by the use of a secondary temperature monitoring device with a known performance and accuracy. By following a test procedure, the set point of the thermal cycler can be set and the temperature monitoring device can relate the actual temperature of the thermal environment. This process is generally repeated for a number of set points to exercise and verify the thermal cycler throughout its operating range.

Currently-available instruments for conducting thermal cycler temperature verification tests typically include three main components: sensor(s), a wiring harness, and a thermometer. The sensor(s) are located inside the thermal cycler environment and are tethered remotely by means of a wiring harness to the thermometer, which is located outside of the thermal cycler.

These currently-available instruments have several disadvantages. First, the wiring harness can present complications during the process of temperature measurements as well as problems with reliability. Most thermal cyclers are not designed to accommodate a temperature monitoring device so a modification to the normal operation can be necessary to extend the cabling from inside the thermal cycler to the thermometer located outside the thermal cycler. The wiring harness may suffer undue stress resulting in failure or intermittent functionality as well as may introduce foreign air currents into the thermal environment that can influence stability. In general, the traditional approach is a laborious process requiring careful wiring harness installation and manual data entry subject to operator error.

A second disadvantage of currently-available instruments is that they typically require an initial calibration at the time of manufacturing and periodically throughout the expected lifetime of the product. Typically, calibration and repair are only available from the original manufacturer or an authorized agent. This can present a significant burden on the user as the availability of a test device or means to perform a quality test of their thermal cycler on a regular basis can be important. Returning the instrument to the manufacturer presents many logistical issues including the coordination with the service company, freight, order processing, traceability, product release and many other similar factors. Furthermore, the calibration service also presents a cost burden on the user. The manufacturer or service agent charges a premium on calibration services and the user is exposed to freight charges, certification report charges, instrument downtime during the time of service, and administrative processing time. In some cases when the instrument is found to be damaged or faulty, the user is then informed and required to approve the repair service or be subject to replacement costs, further exacerbating the problem.

Furthermore, high accuracy devices typically require specialized equipment from the manufacturer to accomplish the calibration process. Specialized software and hardware interfaces are usually needed as a way to calibrate the unit since most high accuracy devices have a proprietary process and can only be calibrated by the manufacturer or a specialized center that has purchased the specialized software and hardware. In the result of a failure or if the performance is in question, (even if only one component is suspect) all of the components of the temperature monitoring device may need to be returned for repair or re-calibration.

### SUMMARY OF THE INVENTION

In accordance with some embodiments of the present inventions, a temperature monitoring system comprising is disclosed that includes a controller and a temperature monitoring device. The temperature monitoring device includes a core and a cartridge. The core includes a processor and a wireless transmitter. The cartridge includes one or more temperature sensors. The controller is configured to receive temperature data transmitted by the temperature monitoring device.

Certain embodiments disclose a temperature monitoring device that includes a temperature sensing element, a radio frequency transmitter, a battery, and a controller, wherein the controller is capable of running a self-calibration routine.

Certain embodiments disclose a wireless sensor unit that includes a frequency-hopping spread spectrum transceiver configured to transmit sensor data and to receive instructions, at least one sensor configured to measure a signal indicative of temperature, and a controller configured to control said transceiver and said at least one sensor. The wireless sensor unit is configured to report data measured by the at least one sensor. The wireless sensor unit is also configured to operate in a low-power mode when not transmitting data or receiving instructions. The wireless sensor unit has an identification code and is configured to implement instructions addressed to the sensor unit according to the identification code. The wireless sensor unit is configured to receive the identification code during a reset interval.

Certain embodiments disclose a wireless sensor system that includes one or more wireless sensor units, where each of said one or more wireless sensor units includes at least one sensor configured to measure a signal indicative of temperature. The wireless sensor unit is configured to receive instructions, and to report data measured by the at least one sensor. The one or more wireless sensor units are configured to operate in a low-power mode when not transmitting or receiving data. The one or more wireless sensors are configured to transmit status information at regular intervals. The wireless sensor system also includes a base unit configured to communicate with the one or more wireless units and to provide data from said one or more sensor units to a monitoring computer. The monitoring computer is configured to log data from one or more of the wireless sensor units.

Certain embodiments disclose a wireless sensor monitoring unit that includes a base unit configured to communicate with one or more wireless sensor units and a monitoring computer. The monitoring computer is configured to log data from one or more of the wireless sensor units. The base unit is configured to send acknowledgements to acknowledge receipt of sensor data from the one or more wireless sensor units. Each of the one or more wireless sensor units includes at least one sensor configured to measure a signal indicative of temperature. Each of the wireless sensor units is configured to receive instructions and run self-diagnostic tests. The one or more wireless sensor units are configured to operate in a low-power mode when not transmitting or receiving data. The one or more wireless sensors are configured to run the self-diagnostic tests and to transmit status information at regular intervals programmed according to commands from the wireless sensor monitoring unit.

### BRIEF DESCRIPTION OF THE DRAWINGS

FIG. 1A is a perspective view of a typical thermal cycler.

FIG. 1B is a perspective view of a typical thermal block.

FIG. 1C is a perspective of a disposable reaction plate.

FIG. 2 is a perspective view of the temperature monitoring system of one embodiment.

FIG. 3 is a perspective view of a temperature monitoring device of the temperature monitoring system of FIG. 2.

FIG. 4 is a cross-sectional view of the temperature monitoring device of FIG. 3.

FIG. 5 is a circuit diagram of the temperature monitoring device of FIG. 3.

FIG. 6A is a top view of an embodiment of the temperature monitoring device of FIG. 2.

FIG. 6B is a top view of an embodiment of the temperature monitoring device of FIG. 2.

FIG. 6C is a top view of an embodiment of the temperature monitoring device of FIG. 2.

FIG. 7A is a side view of an embodiment of the temperature monitoring device of FIG. 2.

FIG. 7B is a side view of an embodiment of the temperature monitoring device of FIG. 2.

FIG. 7C is a side view of an embodiment of the temperature monitoring device of FIG. 2.

### DETAILED DESCRIPTION OF THE PREFERRED EMBODIMENTS

Certain embodiments overcome the disadvantages of currently-available temperature monitoring systems by providing an improved instrument for conducting thermal cycler temperature verification tests. In contrast to the currently-available systems described above, the disclosed systems may locate the thermometer circuitry within the locality of the sensors, thereby allowing for the elimination of the wiring harness and permitting convenient, simple, and effective loading of the sensor into the sample block or reaction chamber. Secondly, certain embodiments include an interchangeable core and disposable sensor cartridges that can be easily separated enabling an exchange for a new or other type of cartridge, potentially eliminating the need to return a unit for calibration service. As a result, this solution can simplify logistical issues and may save the user a tremendous amount of cost. Certain embodiments also include a built-in calibration routine that offers the user the flexibility to calibrate the system on-demand in the field or in the laboratory, when necessary, without the need for specialized hardware and software. Collectively, the system can provide real-time temperature monitoring of the thermal cycler with added convenience, ease-of-use, and increased accuracy and sensitivity.

Certain embodiments disclose a temperature monitoring system that locates the thermometer circuitry within the locality of the sensors and transfers the temperature measurement of the environment wirelessly by, for example, radio frequency data transfer, to a remote receiving unit, thereby eliminating the necessity for a wiring harness. The remote receiving unit may also operate in connection with a secondary controller device to transmit commands to the temperature monitoring device.

In certain embodiments the system includes a modular system whereby certain components are mounted and located in an interchangeable sub-enclosure (core) which mates with a substrate (cartridge) that houses the remainder of the components including sensor components. The system's core contains certain electronic components including the precision temperature processing unit coupled with a wireless data transmitting unit. The core can be compatible with the interchangeable sensor cartridges. The core (containing the mentioned electronic components) can be housed within a removable substrate, thereby permitting the core to be separated from the cartridge. The removable substrate is a self-contained package containing the appropriate interface (i.e. connector) to effectively mate with the cartridges. Different core configurations (e.g. size, shape, forms) are possible to accommodate a variety of cartridge configurations. The ability to separate the core from the cartridge has many advantages; however, a primary advantage is the ability to interchange the core with a variety of cartridge configurations, thereby creating a complete interchangeable system. This gives the user the flexibility of utilizing an assortment of interchangeable cartridges to meet a variety of thermal cycling machine types without the need to purchase a new system in its entirety. The cartridge may contain identification codes which may be written or rewritten to the cartridge by the secondary controller device, during for example, a reset interval. Additionally, the modular nature of this configuration allows a user to easily replace a cartridge if performance, calibration or failure is suspect, thereby substantially reducing downtime.

The cartridge contains the individual sensor housing, sensor elements placed within the housing, a series of electronic parts (e.g. memory chips), and the interface (i.e. connector) that mates with the core. The above mentioned components include items that are typically subject to stress and may exhibit drift throughout the normal usage and lifetime of the product. Therefore, placing these components within the disposable cartridge sensor system provides many advantages. When combined together with the application software, the result is a complete temperature verification system, representing a substantial improvement from the use of an individual temperature probe tethered to a hand-held thermometer.

The modular design of certain embodiments also represents a significant improvement over prior systems. The ability to interchange and utilize a variety of core/cartridge configurations delivers level of flexibility and versatility not found in other systems. Certain embodiments present a comprehensive solution to thermal cycler testing by providing a range of sensor core/cartridge configurations intended to address the variety of thermal cycler instruments available. Apart from the common properties each cartridge shares, each specific sensor cartridge may contain unique features and properties (e.g. sensor housing size, sensor size, number of sensors, and position of the sensors) to suit the specific thermal cycler instrument sample block or reaction chamber (e.g. 96-Well, 0.2 mL tube; 96-well, 0.1 mL tube; 48-well, 0.1 mL tube; 384-well, 0.02 mL tube; dual blocks, quad blocks, low profile block, microfluidic flat block, Cepheid smart tube, carousel holding a glass capillary tube) to be thermally tested. A common thermal cycler reaction chamber is constructed of aluminum, silver, or gold metal block containing a variety of sample wells with a defined geometry (conforms to standard polypropylene sample tubes) that range from 48-wells to over 384-wells. The sizes of the wells within the metal block vary by volume, within a range of 0.02 mL to 0.5 mL, with a majority of the earlier systems containing the larger volume size. Some of the newer systems are designed to optimize the PCR process. In some cases, the metal sample blocks will be designed with a low-mass block or a low-profile block to optimize heating and cooling rates. In other cases, the sample block configurations are changed entirely forming a new thermal cycler system configuration. In general, the market continues to innovate and generate high performance systems offering increased speed, smaller sample volumes, low thermal mass, high temperature uniformity, and other improvements. The modular design of certain embodiments can serve as a solution that addresses the diversity and evolution of these thermal cycler systems.

In some embodiments, the system is configured to measure the temperature of the chemistry sample within an instrument's (e.g. thermal cycler) reaction chamber (e.g. sample well, capillary tube, or reaction vessel). In the case when the actual temperature of the chemistry sample is required, a substrate with embedded material that resembles the typical chemistry samples processed by the variety of the mentioned instruments can be used. The sensor can be placed within the embedded material. The sensor may be calibrated independently from the substrate that houses the sensor to achieve a more accurate measurement of the embedded material, and thus the chemistry sample. The system can be calibrated and optimized to measure the temperature of the chemistry sample and not the immediate external environment. Several mechanisms can be used to minimize and/or remove the influence of the external environment on the actual measurement. Additional embodiments can also be used to measure the temperature of a chemistry sample, some of which will be described in greater detail below.

In certain embodiments, the system can also include synchronized communication with the thermal cycler instrument for automated testing. By utilizing a communication device that conveniently plugs directly into the thermal cycler communication port the devices (e.g. thermal cycler communication device and secondary controller device) and the thermal cycler are able to exchange data, commands, protocol, routines, and other information required to automate the test process and maintain a closed-loop system. The direct communication provides the advantage of simplifying the test process by eliminating possible manual data input errors by the user, allows user to generate a printed report, maintains the integrity of the data, ensures data security, and maintains the secure test records within the system for future access. The local records can remain within the instrument, avoiding and eliminating lost printed records. The local record can be very useful in cases where an instrument repair technician is required to access the history of the thermal cycler for diagnostics.

In certain embodiments, the system may also locate the proprietary calculations and calibration routines inside the temperature monitoring device itself and utilize the existing form of communication (e.g., radio frequency data transfer) as a means to interface with the device for calibration purposes. This simplifies the calibration process by eliminating the need for specialized calibration software or a specialized hardware. The self-calibration feature can be based on a simple command set that prompts the unit to enter into calibration mode. Upon entering this mode the unit is able to run the appropriate routines and prompts an automatic adjustment of the calibration settings within the unit for optimum performance.

In some embodiments, the system is configured as a removable sensor system. An additional added-value feature of this system is the ability of each sensor to store its own discrete calibration information internally, hence, building an independent sensor system enabling the replacement of a sensor without the time consuming reprogramming or calibration effort. Each sensor module can include the components typically subject to drift (e.g. ADC chips, thermistors, bridge circuit) which are individually placed within the removable sensor modules. Each sensor module shares a common connector interface to the substrate that houses the sensor module, enabling complete interchangeability between sensor modules.

In some embodiments, at least some of the electronic components are extended outside of the immediate harsh application environment. In such cases where it is not feasible to locate some of the electronics components within the vicinity of the harsh environment they can be a) located in close proximity to or on the perimeter of the substrate that houses the sensors, b) located on a fixed substrate extending out of the immediate environment, or c) located on a substrate extended out of the environment via a short cable. In each of these configurations, the temperature monitoring device may continue to use the wireless communication capability to transmit the data to a receiving unit.

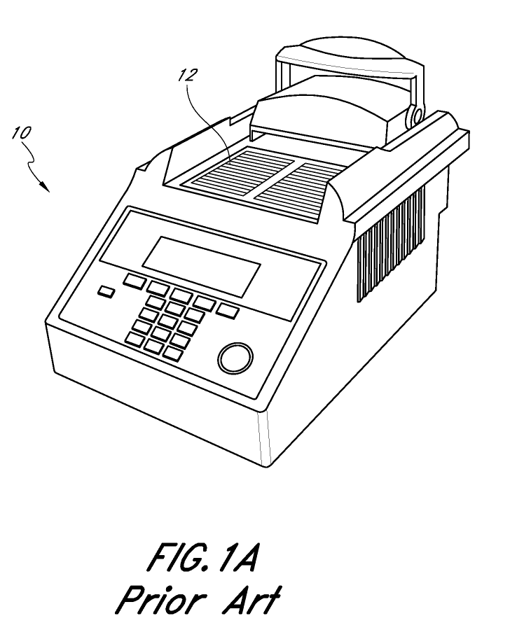

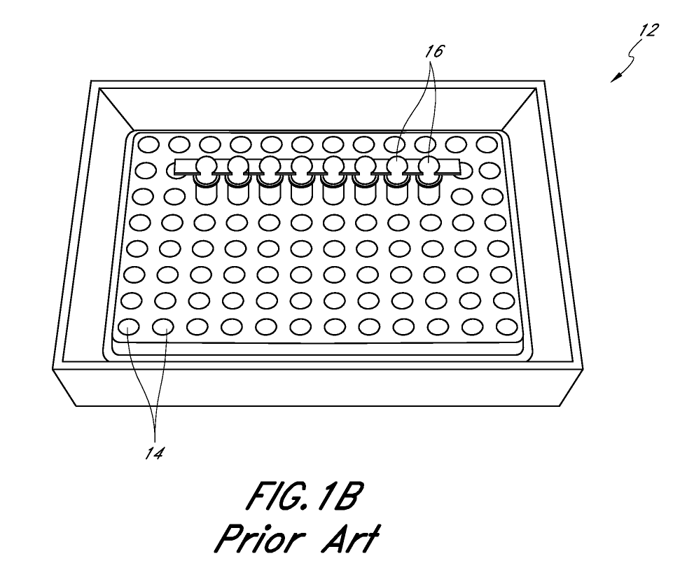

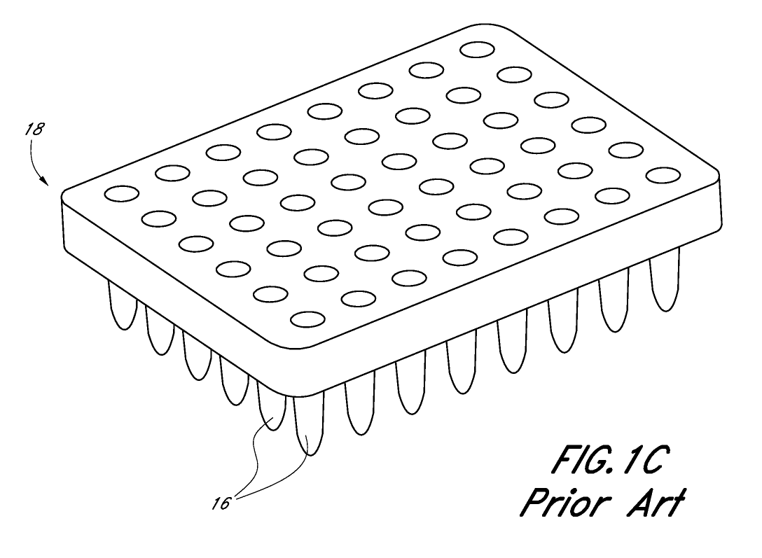

FIG. 1A depicts a typical thermal cycler 10 with a reaction chamber containing a thermal block 12. FIG. 1B is a closer view of a typical thermal block 12 containing multiple wells 14. Since most thermal cyclers heat and cool a biological sample it can be important to prevent contamination of the current biological sample from that of previous and subsequent samples. One way to achieve this is by the use of disposable vials 16 that are shaped to fit and come into direct contact with the thermal cycler block 12 but isolate the sample from direct contact with the block 12. Thus, the thermal energy is transferred from the thermal cycler block 12 to the vial insert 16 and eventually to the biological sample. These vials 16 can be individually located or banked together in a uniform molded unit to form a disposable reaction plate 18 as illustrated in FIG. 1C. For example, a disposable reaction plate 18 may have 96 individual vials 16 formed into one molded piece of plastic. Biological samples are dispensed into the disposable reaction plate 18 with banked pipettes and then loaded in and out of the thermal cycler 10 in a repetitive manner throughout the workday of a clinical laboratory.

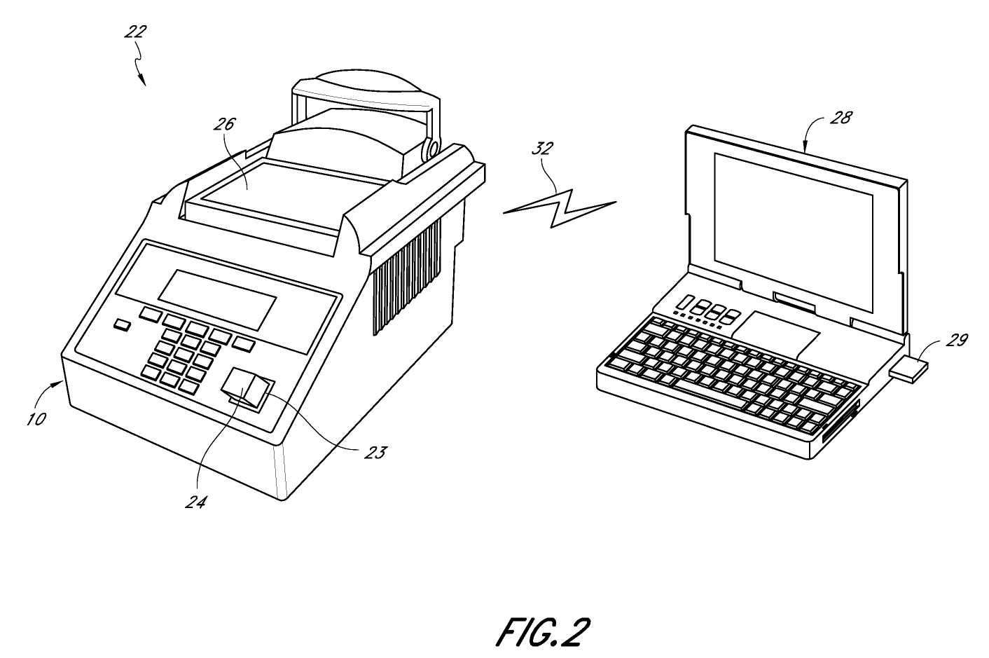

FIG. 2 depicts one embodiment of a temperature monitoring system 22. In the illustrated embodiment, a temperature monitoring device 26 emulates the physical form factor of a particular disposable reaction plate 18 used with the appropriate thermal cycler block 12. The temperature monitoring device 26 is placed in the thermal cycler block 12 just as a disposable reaction plate 18 would normally be placed, thereby contacting the block 12 in the same manner as a disposable reaction plate 18 would, and allowing the thermal cycler 10 to operate under normal operating conditions during a thermal test. In certain embodiments, thermal sensors 36 (not shown in FIG. 2) can be embedded inside an actual reaction plate; replacing where the contents of a biological sample would be with embedding material and a sensor 36. The sensor 36 is held in place and centered in the vial 16 (not shown in FIG. 2) to provide uniform positioning in relation to other thermal sensor embedded vials within the same disposable reaction plate 18. The thermal sensor 36 will experience the same thermal effects as the biological sample.

The temperature monitoring device 26 monitors the temperature inside the thermal cycler's reaction chamber and transmits this data via a wireless connection 32 to a receiving unit 29. The receiving unit 29 may operate in connection with a secondary controller device 28 enabling two-way wireless communication between the secondary controller device 28 and the temperature monitoring device 26, using for example, radio frequency data transfer. The secondary controller 28 will preferentially be equipped with software providing a user interface enabling a user to control and monitor the activities of the temperature monitoring device 26. The secondary controller device 28 can be, for example, a PC Laptop, PDA, cell phone, custom controller, or the like, and can provide the user with the control and display features of the temperature monitoring device 26 without the means of a wired connection. The receiving unit may be, for example, any of a number of wireless receivers. In some embodiments, the temperature monitoring system 22 will also include a thermal cycler communication device 24 configured to interface directly with the thermal cycler 10, by for example, plugging directly into the thermal cycler communication port 23. Such a configuration can allow for greater automation of the testing process. The thermal cycler communication device 24 may also include a wireless communication means to communicate with the temperature monitoring device 26 and the secondary controller device 28. The devices and thermal cycler system can thus exchange data, commands, protocol, routines, and other information required to automate the test process and maintain a closed-loop system. The direct communication can provide the advantage of simplifying the test process by eliminating possible manual data input errors by the user and can ensure data security and integrity by maintaining the secure test records within the system for future access (e.g. within the thermal cycler communication device 24 or within the thermal cycler 10 itself). In some embodiments, the thermal cycler communication device 24 and the secondary controller device 28 may be integrated into a single device.

The interface to the temperature monitoring device 26 can further extend the ability to enter within a user's existing enterprise system (e.g. LAN/WAN, database, servers, etc.). The ability to communicate directly with the temperature monitoring device 26 can eliminate the need for extra instrumentation making the temperature monitoring system 22 ideally suited for mobile use in field testing. The direct communication can also dramatically simplify the entire testing process and the management of the data by, for example, synchronizing the data to a PC for enterprise database storage and control.

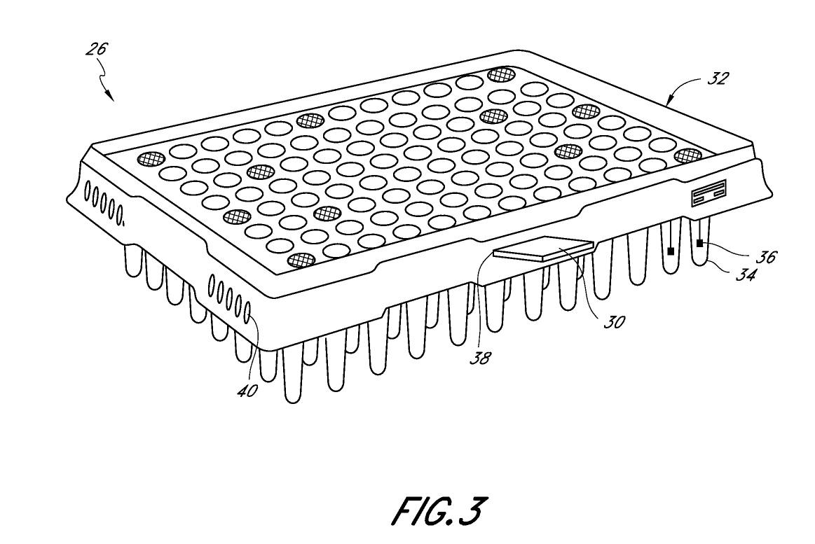

FIG. 3 is a diagram of one embodiment of a temperature monitoring device 26. An electronic component sub-enclosure (core) 30 contains many of the temperature monitoring device's electronic components including the precision temperature processing unit coupled with a wireless data transmitting unit. In a preferred embodiment, the temperature monitoring device 26 is located within the space that would normally be occupied by a disposable reaction plate 18. This allows the operation of the thermal cycler 10 during testing to be similar to normal operation helping to insure accurate test data. The core 30 is joined to the sensor substrate (cartridge) 32 using a connector interface. Each cartridge 32 and core 30 share common and compatible connectors 38. This setup enables a single core 30 to be utilized in combination with a variety of different cartridges configured to be compatible with different thermal cycler configurations. For example, the following are examples of possible cartridge configurations corresponding to common thermal cycler setups: 96-Well & 0.2 mL Tube Instrument cartridge, 96-Well & 0.1 mL Tube Instrument cartridge, 48-Well & 0.1 mL Tube Instruments cartridge, 384-Well & 0.02 mL Tube Instruments cartridge, Standard & Low-profile format cartridges, Micro fluidic card (flat block) Instruments cartridge, Capillary in carousel Tube Instrument cartridge; smart tube block cartridge; and dual and quad block cartridge. Additionally, this interchangeability enables a user to replace a non-functioning or suspect cartridge without requiring the purchase of a new core.

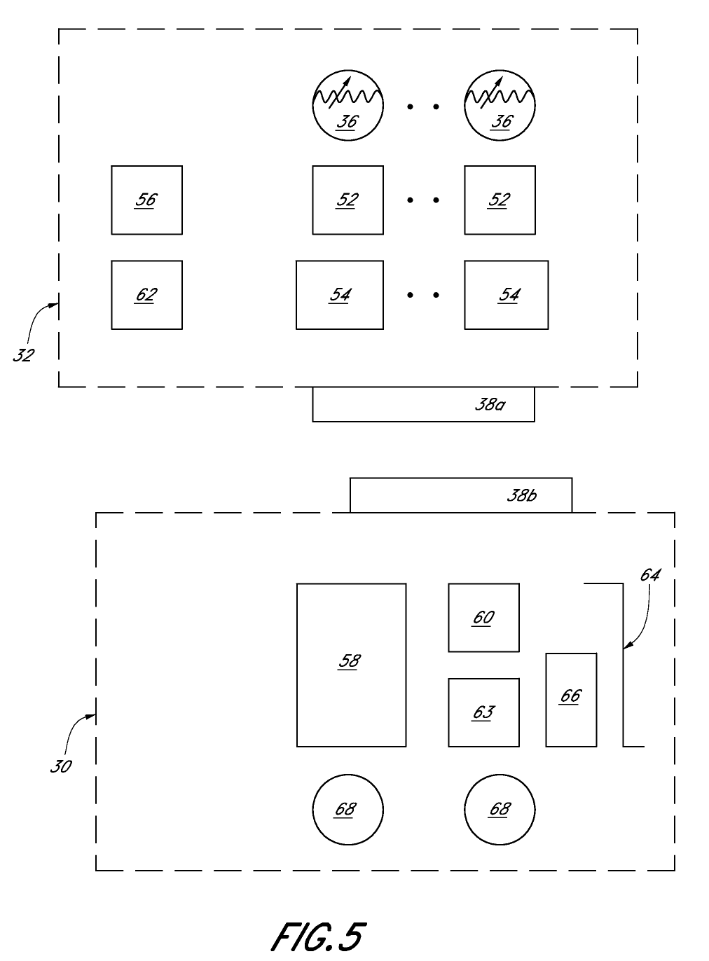

Each cartridge 32 contains one or more sensors 36 enclosed within a sensor housing 34. Each sensor 36 is electrically connected to electronic conditioning (e.g. bridge circuit 52 shown in FIG. 5) and analog-to-digital-conversion (ADC) components 54 (shown in FIG. 5) within the cartridge 32. The onboard microcontroller unit (MCU) 58 (shown in FIG. 5) periodically reads the ADC chips 54 and calculates the temperature of each sensor 36. The temperature of each sensor 36 is transmitted to a receiving unit 29 which may be located in a remote location. Thus, the temperature of the thermal cycler 10 can be monitored in real time telemetry.

In contrast to currently available instruments that include a single sensor, some embodiments of the present invention include a multi-channel sensor platform permitting the temperature test of several locations within the thermal cycler sample block 12. The temperature monitoring system 22 can be configured to acquire the temperature data simultaneously, thereby providing the temperature uniformity (or variation, drift) of the thermal cycler block 12 in real-time. The ability to perform multi-channel temperature tests can save the user a tremendous amount of time resulting in higher productivity and efficiency. In certain, embodiments, the temperature monitoring device 26 may utilize eight sensors 36, one located so as to correspond with each of the four corners of the thermal block 12 and one located so as to correspond with the center of each of four quadrants of the thermal block 12. A typical thermal cycler 10 may utilize four individual heating units corresponding to the four quadrants. Thus, the described sensor configuration can be useful to identify problems with particular heating units within the thermal cycler 10.

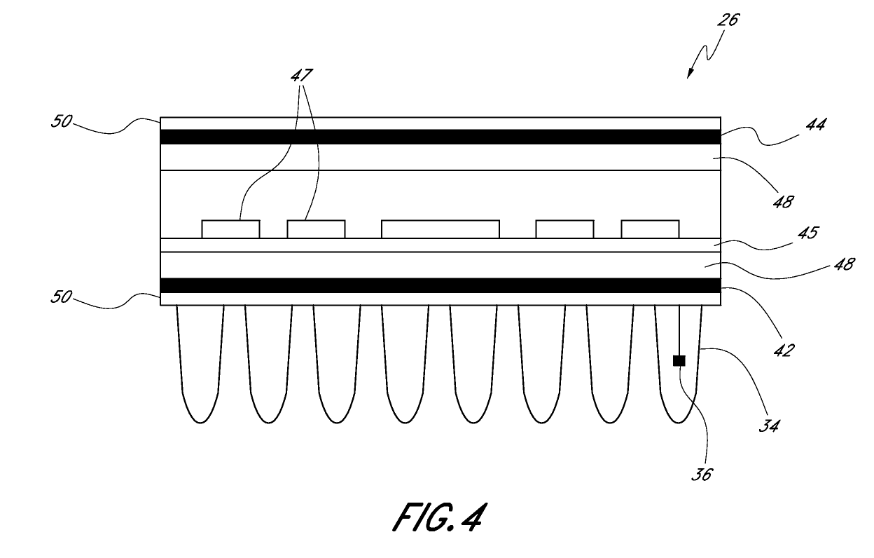

FIG. 4 depicts a cross-sectional view of one embodiment of the temperature monitoring device 26. The enclosure base 42 and lid 44 provide the main structural support for the temperature monitoring device 26 as well as additional thermal isolation for a Main Printed Circuit Board 45 containing some or all of the temperature monitoring device's electronic components 47. The Main Printed Circuit Board 45 can include in certain embodiments all of the core's electronic components, some of which can be seen in FIG. 5, located within the core 30. Additionally the Main Printed Circuit Board 45 may include some of the electronic components associated with the cartridge 32, such as for example, bridge circuit 52, the ADC chips 54, etc. Channels within the enclosure (not shown) may connect to vents 40 (shown in FIG. 3) on the perimeter of the cartridge 32 to provide air circulation between the enclosure base 42 and lid 44 and the Main Printed Circuit Board 45. The enclosure base 42 and lid 44 provide overall protection to the internal components of the temperature monitoring device 26. The enclosure base 42 and lid 44 may be constructed from, for example, polypropylene or polycarbonate. A thermal isolation of the device's electronic components 47 from the operating environment may prevent the device's electronic components 47 from exceeding operating temperature limits. This may be particularly important when the temperature monitoring device 26 is exposed to high temperatures, e.g. temperatures above 85 degrees Celsius. A thin layer of insulation 48 such as woven ceramic, cork, silicon, air, or the like, can be placed above and below the Main Printed Circuit Board 45. Additional layers or thicknesses can be utilized as space permits, for example, layers 50 may be located above and below the enclosure base 42 and lid 44.

The sensor housing 34 provides structural support and the thermal-mechanical interface between the temperature monitoring device 26 and the thermal environment being monitored. The sensor housing 34 contains and protects a thermal sensor 36 in a certain location within the sensor housing 34. A pliable embedding material, such as for example, white silicon grease (heat-sink compound), RTV rubber, or the like, can be used to fill any voids and to provide vibration and shock protection to the sensor 36 as well as provide high thermal conductivity between the sensor 36 and the sensor housing 34. The region immediately between the Main Printed Circuit Board 45 and the sensor housing 34 may be left void or filled with a low thermal conductive material to thermally isolate the sensor housing 34 and the Main Printed Circuit Board 45. The sensor housing 34 may be constructed from the same or similar type of material used to construct the disposable reaction plates 18 used with the thermal cycler 10 so as to emulate their thermal characteristics. For example, many disposable reactions plates are constructed from polypropylene, and thus, this material may be used to form the sensor housing 34.

Additionally, it can be desirable for the sensor housing 34 to closely emulate the physical form factor (e.g., size and shape) of a particular disposable reaction plate 18 used with the appropriate thermal cycler block 12. This allows the sensor housing 34 to make good thermal-mechanical contact with the thermal cycler block 12. More generally, it can be desirable to ensure that each cartridge 32 contain properties necessary to ensure compatibility with a specific type of thermal cycler reaction chamber (e.g. thermal block or carousel). The overall dimensions of the cartridge 32 can be carefully defined in accordance with the type of thermal cycler to be tested. The exact positioning of the sensor 36 and mechanism to hold the sensor 36 in place may also be important to ensure an accurate and repeatable reading. A common thermal cycler reaction chamber type is the 96-Well (well size) 0.2 mL (volume) format. The size of the sensor housing 34 for a cartridge 32 compatible with this reaction chamber is such that it fits within the 0.2 mL well. The specific geometry of the sensor housing 34 (e.g. angle, height, width, tip shape, thickness) adheres to the reaction chamber dimensions. Additional cartridge configurations should generally follow this criterion. For example, in the case of a micro-card flat sample block reaction chamber configuration the cartridge contains the appropriate properties to ensure compatibility. In this scenario, the space between the flat sample block and the heated cover and other mechanisms is limited. Micro sensor elements and customized sensor housing may be incorporated to ensure compatibility with the sample block and space within the reaction chamber. In another thermal cycler type, the capillary in carousel configuration, the cartridge maintains at least one sensor element within a standard capillary (or housing that emulates the capillary) as to insert the sensor as a capillary would normally be placed within or in place of the carousel. The sensor cartridge may contain a single sensor or multiple sensors interconnected in a multi-channel format. In any case, the core electronics may continue to use the radio frequency data transfer capability and transmit the data to the receiving unit 29. This allows a thermal test under the thermal cycler's normal operating conditions, permitting the thermal cycler's cover mechanism to be closed, and eliminates any special wire harness from presenting an interfering factor.

FIG. 5 is a block diagram of circuits of one embodiment of the temperature monitoring device 26. The cartridge 32 is connected to the core 30 via connectors 38a/b. The cartridge 32 contains the sensor elements 36.

The sensors 36 can be, for example, glass encapsulated bead thermistor sensors. It is desirable to use a thermal resistive sensor element that has a high rate of resistance change in proportion to the temperature to which it is exposed. This enables highly precise temperature measurements. In a preferred embodiment the sensor 36 may be an NTS Type GC14/16 Thermistor, a small glass encapsulated chip thermistor on fine diameter platinum alloy lead-wires, available from General Electric. A thermistor sensor element is preferred because of its high rate of resistance change. It can be desirable for the sensor 36 be able to withstand temperatures extending beyond the temperature measurement range to ensure sensor stability and repeatability. A glass encapsulated bead thermistor sensor is typically aged and processed at temperatures around 230° C. providing stable and repeatable readings in the much lower temperature measurement range. A small sensor size is generally preferred to provide a fast response to temperature changes.

Although the sensor 36 is described herein with particular reference to a thermistor sensor, it is recognized that the system of the present invention may utilize a variety of other temperature sensors. Such additional sensors may include any thermal resistive sensor element that may have a high rate of resistance change in proportion to the temperature to which it is exposed.

The sensor 36 is connected to the analog-to-digital converter (ADC) 54 via a bridge circuit 52. The bridge circuit 52 contains one or more bridge resistors, and may be, for example, a partial or half-bridge configuration. The precision reference voltage source 56 applies a voltage to the sensor 36 and bridge circuit 52. A voltage indicative of temperature is then measured by the ADC 52 and converted into a digital value which is stored in the cartridge's short term memory (not shown). The core's microcontroller unit (MCU) 58 periodically reads this value from the ADC 52 and calculates the temperature of each sensor 36 using algorithms which may be stored, for example, internally within the MCU 58 or in the core's non-volatile memory 60 and calibration constants associated with the sensor 36 and which may be stored, for example, in the cartridges's non-volatile memory 62. The core's non-volatile memory 60 may also be used to store additional information such as the core's serial number, manufacturer information, model number, firmware version, downloaded data, and test results catalogued by cartridge serial number, data, etc. The cartridge's non-volatile memory 62 may store the cartridge's serial number, model number, manufacturer information, number of sensors, identification codes, etc. The microprocessor 58 may be, for example, a Texas Instruments CC2430 combination microprocessor and Zigbee RF device. By combining the microprocessor 58 and radio frequency (RF) device 63 into a single-chip solution, savings in chip size and power consumption may be realized. Other processors and RF devices may be used.

A high level of accuracy can be achieved and maintained by combining a high resolution 24 bit sigma delta ADC 54, an extremely sensitive and stable glass bead thermistor (sensor 36), a low temperature coefficient bridge resistor, and a precision ratio-metric reference voltage 56 supplied to these three components. The ADC may be, for example, a Linear Technologies LTC2402. The bridge resistor may be, for example, a 10-12 kΩ resistor with a 0.01% tolerance and a thermal drift of less than 5 ppm. The reference voltage may be, for example, a Linear Technologies LTC1970. Because the measurement range is typically relatively small, from 0 to 110° C., a large percentage of the 24 bit (2²⁴ count) ADC 54 is utilized by selecting the thermistor's nominal resistance value in which the corresponding resistance at the low end and high end of the measurement range is expanded across the ADC range. Furthermore, each individual thermistor is calibrated by realizing a Steinhart & Hart three-point polynomial equation resulting in three constants that accurately describe the resistance to temperature relationship of the thermistor across the entire calibration range. An initial calibration laboratory accuracy of plus or minus 0.005° C. can be realized at the time of calibration and plus or minus 0.025° C. can be realized thereafter, providing an overall accuracy well within the generally desired range for a thermal cycler of plus or minus 0.05° C. to 0.1° C., during the expected calibrated period of the temperature monitoring device 26.

The temperature monitoring device 26 may operate with a portable power cell (battery 68) located within a short proximity of the device 26—typically within the device 26. A portable power cell such as a 3.3 V coin cell battery can be used but may operate within a temperature range from 0 to 85° C. As another example, the battery 68 may a polymer lithium-ion 3.7 V battery, such as a Powerizer PL042447. It is generally desirable to use a battery 68 with a small size, long-lasting supply of power, and high heat tolerance. The battery 68 may have the capability of producing a peak supply current of 50 mA for short bursts of 150 ms to the MCU and Radio RF components; otherwise a continuous supply current of 25 mA is required during idle operation of the temperature monitoring device 26. Multiple batteries can be ganged together to meet the device's voltage and current requirements. A rechargeable battery may be preferred so as to provide multiple uses from the temperature monitoring device 26 by either removing a battery sub-assembly for recharging or by plugging the temperature monitoring device 26 into a charger base station while not in use. The smallest battery that meets the operating conditions is preferred as the temperature monitoring device 26 has a limited amount of space for the battery 68.

The calculated temperature is transmitted to the receiving device 29 via the radio frequency device 63. The RF device 63 may include, for example, a frequency-hopping spread spectrum transceiver. Frequency-hopping spread spectrum is a method of transmitting radio signals by rapidly switching a carrier among many frequency channels, using a pseudorandom sequence known to both the transmitter and receiver. As described above, it may be desirable to use a combination microprocessor/RF device. The antenna 64 and antenna matching components 66 receive radio frequency signals from, and transmit them to, the receiving unit 29. The antenna 64 may be a PCB or “on-chip” antenna. The antenna matching components 66 may include a balun. Also as described above, the receiving unit 29 may be connected to a secondary controller device 28 such as a standard hand-held PDA or PC.

In certain embodiments, the MCU 58 utilizes a real time operating system (RTOS) which functions to provide several dedicated RTOS subroutines (or threads) within the total firmware the illusion of having their own processor. The RTOS makes good use of the MCU's processor time by using internal hardware interrupts and timers. Each thread may handle a portion of the main functions of the temperature monitoring device 26. For example separate threads may be utilized to handle each of the following: RF Wireless Protocol Stack (managing wireless communication traffic), Periodic ADC Temperature Conversion, and Command Interpreter (managing and responding to commands received from the secondary controller device).

A Power Management thread can be utilized to cooperate with the RTOS to reduce power consumption by reducing the MCU's clock frequency during idle states and by shutting off hardware internal and external subsystems when not in use.

The RTOS also provides a Periodic ADC temperature conversion thread to read the data from the ADC 54 and through a series of mathematical equations, convert the ADC data to a value that represents the temperature of each sensor 36. The Periodic ADC temperature conversion thread utilizes subroutines from a Low Level Hardware Interface collection to capture the converted data from each ADC chip 54 and store the values in known data memory locations residing in the MCU 58. The amount of time it takes the MCU 58 to read the ADC chips 54 is very small compared to the amount of time the ADC chips 54 take to convert an analog reading to a digital reading. A typical high resolution ADC chip has a conversion rate of approximately 140 milliseconds and an approximate read time of a few microseconds. Therefore, the Periodic ADC temperature conversion thread is idle for a known period of time, after which time it reads all the ADC chips 54, converts to temperature as needed and then returns to an idle state. The Power Management system can take advantage of this idle time by reducing MCU clocks and other internal and external hardware not required to operate during an ADC conversion. This can reduce power consumption and electrical noise generated by the system clocks and other chips while the ADCs 54 are converting data. The Periodic ADC temperature conversion thread utilizes parameters to determine the course of action to take in the process of converting an ADC reading to temperature. It may or may not be necessary to complete a full temperature conversion process every time the ADC chips 54 are read. The Periodic ADC temperature conversion thread utilizes algorithms from a Mathematical Calculation collection in a series of steps to convert the raw ADC conversion reading to a finalized value that represents the temperature of the sensor. The ADC value may be stored in a short-term memory location for diagnostics. The Mathematical Calculation collection may be stored, for example, internally in the MCU 58. First, the resistance of the sensor 36 is calculated based on the bridge circuit 52 and the ADC conversion value. The resistance value may be stored in a short-term memory location for diagnostics (as opposed to simply being stored in a register). Next, the resistance value is used to determine the temperature of the sensor 36. The temperature is calculated based on the calculated resistance of the sensor 36 and on parameters that characterize each sensor 36. These characterized parameters are stored either internally in the MCU, in the core's non-volatile memory 60 or externally in a non-volatile memory device (e.g. non-volatile memory 62 located on the cartridge) and are determined at time of calibration. The calculated temperature value of each sensor 36 may be stored for diagnostics. Next, a FIFO digital filter can be utilized to provide a running average of the readings, helping to smooth the output temperature data. The averaged temperature values can be stored for diagnostics and for final output as requested by the secondary controller device 28 in normal operation. The number of FIFO positions can be a system parameter. Other filtering and averaging techniques can be used. Intermediate calculations can be performed to compensate for sensor self heating and lead resistance as needed and as determined by system parameters.

In certain embodiments, the temperature monitoring device 26 may be configured to facilitate a variety of diagnostic tests. For example, the temperature monitoring device 26 may return a variety of internal parameters such as the measured resistance of the sensors, value of the calibration constants, the temperature before and after FIFO digital filtering, the raw ADC count, resistance of the bridge circuit, etc. The temperature monitoring device 26 may also be configured to return other diagnostic information such as the strength of the radio frequency signal, battery voltage, or the like. The temperature monitoring device 26 may allow a user to write values of internal parameters via the secondary controller device 28 for diagnostic purposes. The temperature monitoring device 26 may also be configured to periodically run a variety of self-diagnostic processes, for example, at startup, and output an alarm or notification to the secondary controller device 28 if a problem is detected. For example, the temperature monitoring device 26 may be configured to detect a malfunctioning sensor and notify the user.

Some embodiments of the temperature monitoring system 22 simplify the calibration process by eliminating the need for specialized calibration software or a specialized hardware interface by locating the proprietary calibration calculations and routines inside the temperature monitoring device 26 itself and utilizing the existing wireless form of communication as a means to interface with the temperature monitoring device 26 via the secondary controller device 28.

In certain embodiments, three different temperatures within the temperature measurement range of the temperature monitoring device are used to achieve a highly precise level of calibration. Typically one temperature close to the low end of the temperature range, one located near the high end of the temperature range, and one located near the middle of the temperature range are selected. The sensors 36 are placed in a temperature controlled environment such as a circulating liquid bath that is capable of maintaining a stable temperature. The actual temperature of the medium in the calibration bath is monitored with a calibration grade reference thermometer. The temperature of the medium does not have to exactly match the set point, it just needs to be stable and measured accurately. Once the calibration bath is stable at the set point, the user enters the temperature reading from the reference thermometer along with the set point enumeration (e.g. 1, 2, or 3) in the secondary controller device 28. This process is repeated for each set point. A function on the secondary controller device 28 is provided as a means for the user to signal that all of the set points have been completed.

The Command Interpreter receives specific commands in regards to the calibration process. These commands are originated by a secondary controller device 28, which are transmitted via wireless communication to the temperature monitoring device 26 and handled by the RF Wireless Protocol Stack. There are a few preferred commands to carry out a calibration sequence: (1) A set point enumeration with a temperature in degrees Celsius in plain ASCII text, for example “SP1 24.98” to indicate Set Point One and 24.98 degrees Celsius; and (2) A finalization command in plain ASCII text to indicate that all set points for a given sequence have been accomplished, for example “Calc” to indicate a Calculation is needed to finish the sequence. Other commands can be used, for example, to return diagnostic information. For each Set Point the Command Interpreter validates the data and converts the plain text value of the temperature to an internal binary number and then stores the data internally in known locations. The temperature data is then used to calculate the calibration constants, which overwrite default values based on nominal resistance values of the sensors. In certain embodiments, it is possible for just one Set Point to be processed if only one temperature is in question or is desired to have a higher accuracy. The default values are overwritten as each Set Point is received. In the above example, a single Set Point would be processed followed by the finalization command. After the Command Interpreter receives the finalization command, a specific calculation is performed from the Mathematical Calculation Collection. The Command Interpreter will insure that the Periodic ADC temperature conversion thread is running during any Calibration Set Point Command to provide current resistance readings of all the sensors 36. Based on three sets of values; the actual sensor temperature and resistance of each sensor for the three temperatures, an algorithm from the Mathematical Calculation Collection will derive Steinhart and Hart values a, b, and c for each sensor 36 that characterize each sensor 36 more accurately than the default values of each sensor 36. These values are stored and used to convert resistance readings to temperature for each sensor 36 during normal operation of the temperature monitoring device 26.

The primary structure of the firmware can be written in such a way as to operate and make decisions based on parameters. This can enables the firmware's primary structure to remain the same for a given family of products, while parameters can be set to provide flexibility in operation to support different models in the families of products. Most of the parameters are set at time of manufacture and test. By varying the value of a parameter, one can change the functionality or performance of the temperature monitoring device 26 without changing the primary structure of the firmware. Parameters are also used by the Mathematical Collections as values in the calculations to derive temperature and other data of use to the user or for diagnostics. Parameters are also the result of calculations that are stored for normal operational use of the device. Parameters can be stored in various physical locations. Most of the system parameters may be stored within the MCU 58 in nonvolatile memory and are initialized at the time of manufacture and test. Other parameters may be stored in physical memory chips that can be located on any of the device printed circuit boards or within a sensor sub-assembly. A Parameter Handler thread is responsible for reading and writing values to and from the various memory storage areas, converting values to the proper data type, and storing the values in the proper locations used by the temperature monitoring device 26.

The RF Wireless Protocol enables communication between the temperature monitoring device 26 and the secondary controller device 28. The wireless interface serves as the means for the user to control and monitor the activities of the temperature monitoring device 26 without the typical use of buttons and indicators located on the temperature monitoring device 26. This is commonly referred to as a “headless device.” The secondary controller device 28 is equipped with the same RF protocol and complimentary proprietary functions. This allows the temperature monitoring device 26 to perform its functions in a remote location from the secondary controller device 28. The RF Wireless Protocol handles complex issues involved with wireless communication such as networking multiple devices, communication arbitration and collision, data security, data acknowledgement, data forwarding to other similar devices and coexisting with other non-similar devices. The RF Wireless Protocol provides the means to receive commands from a secondary controller device 28 and submit the commands to the Command Interpreter thread for proper execution within the temperature monitoring device 26. The RF Wireless Protocol also provides a means for the Command Interpreter to respond to a secondary controller device 28 in the form of an acknowledgement or data requested by submitting the data from the Command Interpreter to the RF Wireless Protocol for wireless communication to the secondary controller device 28. The RF Wireless Protocol can be either a custom “home brew” solution or a standardized solution such as “Zigbee.”

In some embodiments, the core's electronic components 47 are extended outside of the immediate harsh application environment. In such cases where it is not feasible to locate the electronic components 47 within the vicinity of the harsh environment they can be a) located in close proximity to or on the perimeter of the cartridge 32 that houses the sensors 36, b) located on a fixed substrate 76 extending out of the immediate environment, c) located on a substrate 80 extended out of the environment via a short cable 78. Additional configurations are also possible. In each of these configurations, the core 30 may continue to use the radio frequency data transfer capability to transmit data to the receiving device 29.

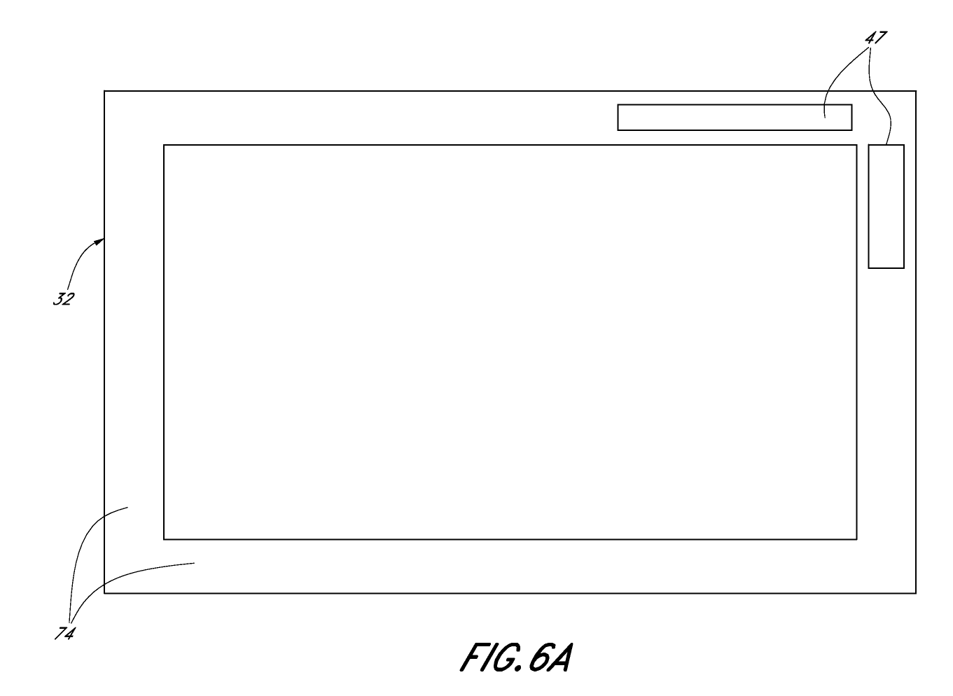

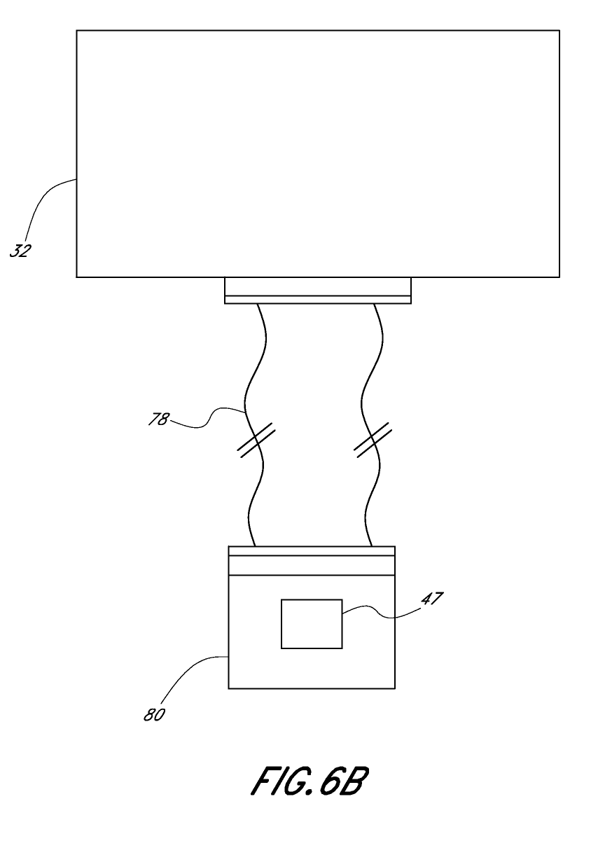

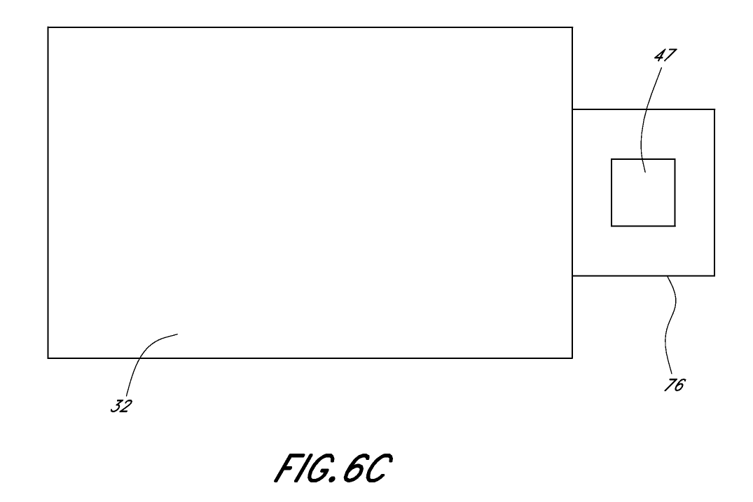

In certain embodiments it may be desirable to extend some of the temperature monitoring device's electronic components 47 outside of the immediate harsh environment, as illustrated in FIGS. 6A-C. This may permit the temperature monitoring device 26 to be used with the manufacturer's special factory test conditions. These conditions can include the use of the heated cover mechanism and other parameters not necessarily found within a standard end-user test protocol. As described above, the purpose of the heated cover mechanism, under normal operating conditions, is to press against the lids of the reaction tubes to prevent condensation of water from the reaction mixtures to the insides of the lids, making it unnecessary to use PCR oil. The use of the heated cover during a thermal test ensures the test results accurately represents the instrument's performance under these conditions, thus the test results reflect the actual temperature experienced by the sample within the reaction chamber. It is commonly found that the heated cover mechanism influences the immediate sample block environment by introducing heat of over 105° C. within an enclosed compartment. The enclosed compartment ensures that the immediate environment is shielded and not influenced by the external environment (i.e. ambient air currents) that can influence a thermal test. However, the heated cover mechanism along with the other special test parameters can generate a fairly harsh environment for electronic components 47 when placed within this immediate environment. Therefore, removing these components 47 out of this harsh environment permits the temperature monitoring system 22 to perform thermal tests without being subject to any unwanted influence or undue stress or damage.

FIG. 6A illustrates how electronic components 47 that are subject to stress by this harsh environment can be placed around the perimeter of the cartridge 32 that houses the sensors. The perimeter can be provided with a variety of materials including low thermal conductive material to protect the components 47 from the high heat application. The perimeter is located within the proximity of the sensors 36 and contains the appropriate connections (e.g. communication lines) to maintain sensor signals and other processes in place. The thermal cycler instrument's compartments (e.g. heated cover mechanism, mechanical slide tray, mechanical door mechanism) may provide additional protection by creating a barrier between the immediate harsh internal environment and the remaining exterior components.

FIG. 6B illustrates how one embodiment utilizes a short cable 78 to extend the components 47 subject to stress out of the environment. The cartridge 32 that houses the sensors remains within the immediate environment and is connected to the remaining components 47. A standard interface or connector is used on each end of the short cable 78. The remaining components 47 are housed within a protective sub-enclosure 80 which may be composed of several interconnecting parts.

FIG. 6C illustrates how one embodiment utilizes a fixed substrate 76 that extends out of the immediate environment. The fixed substrate 76 may be provided with an insulating material to further protect the electronic components 47.

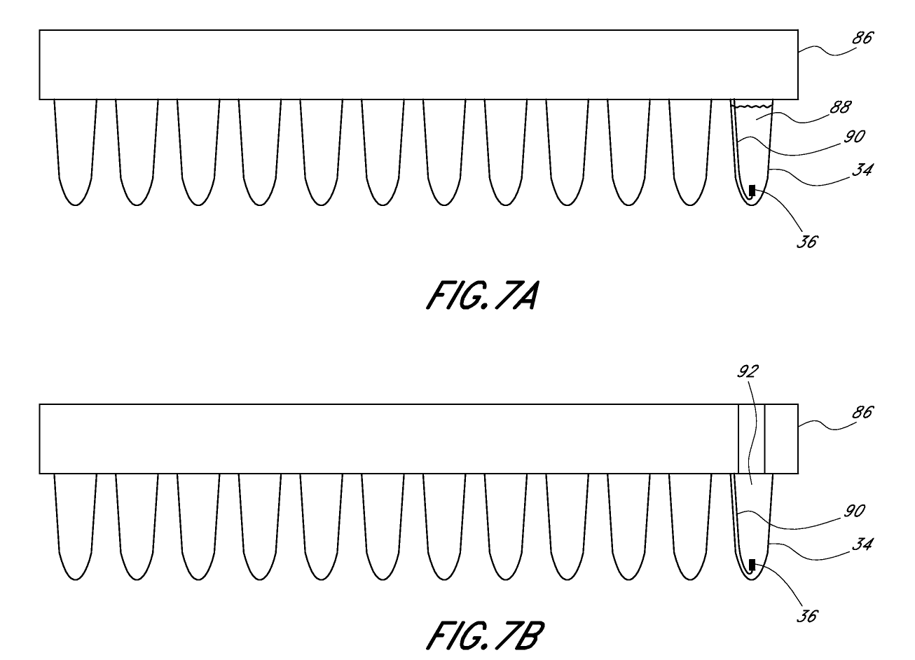

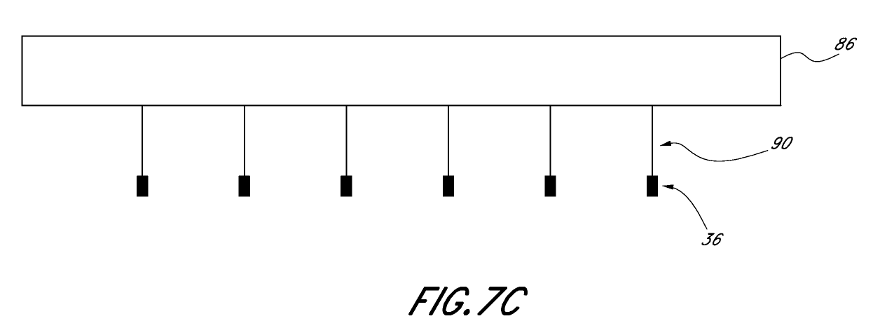

FIGS. 7A-C depict embodiments the temperature monitoring device 26 configured to measure the temperature of a chemistry sample dispensed into a reaction chamber vessel (e.g. vial 16) rather than the temperature of the thermal cycler block 12. In some cases, it may be important to know the temperature of the chemistry sample, and this value may differ from the temperature of the thermal block 12. Thermal cyclers generally use a proportional-integral-derivative (PID) controller to provide feedback control of the thermal block's temperature. The thermal cycler's PID controller may be set to a certain temperature, but the chemistry sample will realize a certain offset or distorted temperature in relation to the PID setting. These embodiments provide an “in vitro” calibrated temperature monitoring system that can measure the temperature of the chemistry sample. In this case, the calibrated probe would be a small leaded sensor 36 that would be inserted into the chemistry sample. Thus, a calibrated thermometer would display the temperature of the sensor in the chemistry sample, i.e. the temperature of the chemistry sample, and not the block. The PID controller set point could then be adjusted to compensate for the discrepancy, e.g. if the desired chemistry sample temperature is 37, it may be determined that a PID set point of 37 results in an in vitro temperature measurement of 36.8. In that case, the PID controller would be adjusted to, for example, 37.2 to yield an actual chemistry sample temperature of 37. This is a simple example and may not be repeatable. Interpolation or extrapolation is not necessarily accurate so a point by point real time monitoring system may be necessary.

An “off the shelf” standardized solution is not suitable for this application; the closest and most typical being a thermocouple wire probe with an associated thermocouple thermometer. There are several problems with an “off the shelf” standardized solution that render it unsatisfactory including: (1) the size of sensor and lead wire, (2) the stem effect of the lead wire, (3) self heating of sensor, and (4) the difficulty of managing multiple sensor locations across the block. Further complications of an “off the shelf” standardized solution arise from a typical thermal cycler's lack of temperature uniformity across the block. For this reason, multiple temperature readings would ideally be taken at the same time across the block (e.g. eight thermometers with 36 inch lead wires held in place to carefully measure the center of a vial/well) requiring careful positioning and difficult adjustments potentially jeopardizing an accurate measurement.

In some embodiments, the temperature monitoring system 22 is configured to measure the liquid or chemistry sample within the instrument's (i.e. thermal cycler) reaction chamber (e.g. sample well, capillary tube, or reaction vessel). A micro sensor 36 is suspended from the main substrate 86. The total length of the lead wire 90 of the sensor 36 may be minimalized to be less than 1 inch in most cases thereby reducing stem effect normally associated with an off the shelf solution. The sensor size may also be minimalized in overall size to be less than 0.025 inch with a lead wire diameter less than 36 gauge therefore also minimalizing stem effect and mass ratio of the sensor and lead wire compared to the reaction vessel volume. The disclosed embodiments can support multiple sensors 36 enabling temperature monitoring of the liquid in various locations across the block 12. In order for this embodiment to accurately measure the temperature of the liquid within a vessel, the sensors 36 are calibrated without any embedding material, i.e. the bare sensor is calibrated. Compensation for the small size of the sensor and the small volume of the liquid in the vessel is accomplished in the calculations to subtract the self heating factor from the sensor. Therefore this embodiment provides a suitable solution by minimalizing or eliminating the problematic contributors of off the shelf solutions described above.

FIG. 7A illustrates one embodiment of a temperature monitoring device 26 configured to measure the temperature of a chemistry sample, as opposed to measuring the temperature of the thermal block 12. A sensor housing 34 that resembles the most common reaction plate may be used. The sensor 36 is embedded in a material 88 that resembles the typical chemistry samples processed by the thermal cycler 10 or that resembles a specific chemistry sample in question. The sensor 36 is placed within this material 88. The sensor 36 is calibrated independently and prior to permanent placement into the sensor housing 34 to achieve a more accurate measurement of the embedded material 88, thus the chemistry sample. The system is calibrated and optimized to measure the temperature of the chemistry sample and not the immediate external environment.

FIG. 7B illustrates another embodiment of a temperature monitoring device 26 configured to measure the temperature of a chemistry sample. A sensor housing 34 that resembles the most common reaction plate is used. The sensor 36 is positioned within a vacant sensor housing 34. A means to fill and empty the vessel with various liquid materials is provided by means of access to the sensor housing 36 through an access hole 92 above each sensor position. The sensor 36 is calibrated independently and prior to permanent placement into the sensor housing 34 to achieve a more accurate measurement of the deposited materials or chemistry samples. The system is calibrated and optimized to measure the temperature of the chemistry sample and not the immediate external environment.

FIG. 7C illustrates another embodiment of a temperature monitoring device 26 configured to measure the temperature of a chemistry sample. This embodiment does not utilize sensor housings. Instead, each sensor 36 is suspended from the main substrate 86 via a sensor lead wire 90 and held in correct position to line up with vessels in the instrument. The sensors 36 are immersed into the chemistry sample of each vessel as the temperature monitoring device 26 is placed onto the instrument block 12.

### Thermistor Operation

A brief explanation of a thermistor's operation will now be provided. A thermistor is a type of resistor used to measure temperature changes, relying on the change in its resistance with changing temperature.

Assuming that the relationship between resistance and temperature is linear (i.e. we make a first-order approximation), then:

ΔR=kΔT

where

ΔR=change in resistance

ΔT=change in temperature

k=first-order temperature coefficient of resistance.

Thermistors may be classified into two types depending on the sign of k. If k is positive, the resistance increases with increasing temperature, and the device is called a positive temperature coefficient (PTC) thermistor, Posistor. If k is negative, the resistance decreases with increasing temperature, and the device is called a negative temperature coefficient (NTC) thermistor. Resistors that are not thermistors are designed to have the smallest possible k, so that their resistance remains almost constant over a wide temperature range.

In practice, the linear approximation (above) works mainly over a small temperature range. For accurate temperature measurements, the resistance/temperature curve of the device can be described in more detail. The Steinhart-Hart equation is a widely used third-order approximation:

$$\frac{1}{T} = a + b ln ( R ) + c {ln}^{3} ( R )$$

where a, b and c are called the Steinhart-Hart parameters, and may be specified for each device. T is the temperature in kelvin and R is the resistance in ohms. To give resistance as a function of temperature, the above can be rearranged into:

$$R = {e}^{{( β - \frac{α}{2} )}^{\frac{1}{3}} - {( β + \frac{α}{2} )}^{\frac{1}{3}}}$$

$$where$$

$$α = \frac{a - \frac{1}{T}}{c} and β = \sqrt{{( \frac{b}{2 c} )}^{3}} + \frac{{α}^{2}}{4}$$

The error in the Steinhart-Hart equation is generally less than 0.02° C. in the measurement of temperature. As an example, typical values for a thermistor with a resistance of 3000Ω at room temperature (25° C.=298.15 K) are:

a=1.40×10⁻³

b=2.37×10⁻⁴

c=9.90×10⁻⁸

NTC thermistors can also be characterized with the B parameter equation, which is essentially the Steinhart Hart equation with c=0.

$$\frac{1}{T} = \frac{1}{T} + \frac{1}{B} ln ( \frac{R}{{R}_{0}} )$$

where the temperatures are in kelvin. Using the expansion only to the first order yields:

R₀e^{B(1/T-2/To)}

or

R=rₒₒe^{B/T}

or

$$T = \frac{B}{ln ( R / {r}_{oo} )}$$

where

R₀ is the resistance at temperature T₀ (usually 25° C.=298.15 K)

rₒₒ=R₀·e^{-B/To}

Many NTC thermistors are made from a pressed disc or cast chip of a semiconductor such as a sintered metal oxide. They work because raising the temperature of a semiconductor increases the number of electrons able to move about and carry charge—it promotes them into the conducting band. The more charge carriers that are available, the more current a material can conduct. This is described in the formula:

I=n·A·v·e

I=electric current (ampere)

n=density of charge carriers (count/m³)

A=cross-sectional area of the material (m²)

v=velocity of charge carriers (m/s)

e=charge of an electron (coulomb)

The current is measured using an ammeter. Over large changes in temperature, calibration is necessary. Over small changes in temperature, if the right semiconductor is used, the resistance of the material is linearly proportional to the temperature. There are many different semiconducting thermistors and their range goes from about 0.01 Kelvin to 2,000 Kelvins (−273.14° C. to 1,700° C.).

Most PTC thermistors are of the “switching” type, which means that their resistance rises suddenly at a certain temperature. The devices are made of a doped polycrystalline ceramic containing barium titanate (BaTiO3) and other compounds. The dielectric constant of this ferroelectric material varies with temperature. Below the Curie point temperature, the high dielectric constant prevents the formation of potential barriers between the crystal grains, leading to a low resistance. In this region the device has a small negative temperature coefficient. At the Curie point temperature, the dielectric constant drops sufficiently to allow the formation of potential barriers at the grain boundaries, and the resistance increases sharply. At even higher temperatures, the material reverts to NTC behavior. The equations used for modeling this behavior were derived by W. Heywang and G. H. Jonker in the 1960s.

Another type of PTC thermistor is the polymer PTC, which is sold under brand names such as “Polyfuse”, “Polyswitch” and “Multiswitch”. This consists of a slice of plastic with carbon grains embedded in it. When the plastic is cool, the carbon grains are all in contact with each other, forming a conductive path through the device. When the plastic heats up, it expands, forcing the carbon grains apart, and causing the resistance of the device to rise rapidly. Like the BaTiO3 thermistor, this device has a highly nonlinear resistance/temperature response and is used for switching, not for proportional temperature measurement.

When a current flows through a thermistor, it will generate heat which will raise the temperature of the thermistor above that of its environment. If the thermistor is being used to measure the temperature of the environment, this self-heating effect may introduce an error if a correction is not made.

The electrical power input to the thermistor is just

P_{E}=IV

where I is current and V is the voltage drop across the thermistor. This power is converted to heat, and this heat energy is transferred to the surrounding environment. The rate of transfer is well described by Newton's law of cooling:

P_{T}=K(T(R)−T₀)

where T(R) is the temperature of the thermistor as a function of its resistance R, T0 is the temperature of the surroundings, and K is the dissipation constant, usually expressed in units of milliwatts per ° C. At equilibrium, the two rates may be equal.

P_{E}=P_{T}

The current and voltage across the thermistor will depend on the particular circuit configuration. As a simple example, if the voltage across the thermistor is held fixed, then by Ohm's Law we have I=V/R and the equilibrium equation can be solved for the ambient temperature as a function of the measured resistance of the thermistor:

$${T}_{0} = T ( R ) - \frac{{V}^{2}}{KR}$$

The dissipation constant is a measure of the thermal connection of the thermistor to its surroundings. It is generally given for the thermistor in still air, and in well stirred oil. Typical values for a small glass bead thermistor are 1.5 mw/° C. in still air and 6.0 mw/° C. in stirred oil. If the temperature of the environment is known beforehand, then a thermistor may be used to measure the value of the dissipation constant. For example, the thermistor may be used as a flow rate sensor, since the dissipation constant increases with the rate of flow of a fluid past the thermistor.

Different or additional algorithms, constants, filters, etc. may be used in connection with the derivation of temperature from a thermistor's measured resistance.

### Wireless Protocol

Various wireless protocols can be used with the embodiments of this invention. ZigBee is the name of one such protocol, which is a specification for a suite of high level communication protocols using small, low-power digital radios based on the IEEE 802.15.4 standard for wireless personal area networks (WPANs). The relationship between IEEE 802.15.4-2003 and ZigBee is similar to that between IEEE 802.11 and the Wi-Fi Alliance. The ZigBee 1.0 specification was ratified on Dec. 14, 2004.

ZigBee operates in the industrial, scientific and medical (ISM) radio bands; 868 MHz in Europe, 915 MHz in the USA and 2.4 GHz in most jurisdictions worldwide. The technology is intended to be simpler and cheaper than other WPANs such as Bluetooth. The most capable ZigBee node type is said to require only about 10% of the software of a typical Bluetooth or Wireless Internet node, while the simplest nodes are about 2%. However, actual code sizes are much higher, closer to 50% of Bluetooth code size.

ZigBee has started work on version 1.1. Version 1.1 is meant to take advantage of improvements in the 802.15.4b specification, most notably that of CCM* as an alternative to CCM (CTR+CBC−MAC) CCM mode. CCM* enjoys the same security proof as CCM and provides greater flexibility in the choice of Authentication and Encryption.

ZigBee protocols are intended for use in embedded applications requiring low data rates and low power consumption. ZigBee's current focus is to define a general-purpose, inexpensive, self-organizing, mesh network that can be used for industrial control, embedded sensing, medical data collection, smoke and intruder warning, building automation, home automation, domotics, etc. The resulting network will use very small amounts of power so individual devices might run for a year or two using the originally installed battery.

There are three different types of ZigBee device:

ZigBee coordinator (ZC): The most capable device, the coordinator forms the root of the network tree and might bridge to other networks. There is exactly one ZigBee coordinator in each network. It is able to store information about the network, including acting as the repository for security keys.

ZigBee Router (ZR): Routers can act as an intermediate router, passing data from other devices.

ZigBee End Device (ZED): Contains just enough functionality to talk to its parent node (either the coordinator or a router); it cannot relay data from other devices. It requires the least amount of memory, and therefore can be less expensive to manufacture than a ZR or ZC.

The protocols build on recent algorithmic research (Ad-hoc On-demand Distance Vector) to automatically construct a low-speed ad-hoc network of nodes. In most large network instances, the network will be a cluster of clusters. It can also form a mesh or a single cluster. The current profiles derived from the ZigBee protocols support beacon and non-beacon enabled networks.

In non-beacon enabled networks (those whose beacon order is 15), an unslotted CSMA/CA channel access mechanism is used. In this type of network ZigBee Routers typically have their receivers continuously active, requiring a more robust power supply. However, this allows for heterogeneous networks in which some devices receive continuously, while others may only transmit when an external stimulus is detected. The typical example of a heterogeneous network is a wireless light switch: the ZigBee node at the lamp may receive constantly, since it's connected to the mains supply, while a battery-powered light switch would remain asleep until the switch is thrown. The switch then wakes up, sends a command to the lamp, receives an acknowledgment, and returns to sleep. In such a network the lamp node will be at least a ZigBee Router, if not the ZigBee Coordinator; the switch node is typically a ZigBee End Device.

In beacon enabled networks, the special network nodes called ZigBee Routers transmit periodic beacons to confirm their presence to other network nodes. Nodes may sleep between beacons, thus lowering their duty cycle and extending their battery life. Beacon intervals may range from 15.36 milliseconds to 15.36 ms*214=251.65824 seconds at 250 kbit/s, from 24 milliseconds to 24 ms*214=393.216 seconds at 40 kbit/s and from 48 milliseconds to 48 ms*214=786.432 seconds at 20 kbit/s. However, low duty cycle operation with long beacon intervals requires precise timing which can conflict with the need for low product cost.

In general, the ZigBee protocols minimize the time the radio is on so as to reduce power use. In beaconing networks, nodes may be active while a beacon is being transmitted. In non-beacon enabled networks, power consumption is decidedly asymmetrical: some devices are always active, while any others present spend most of their time sleeping.

ZigBee devices are required to conform to the IEEE 802.15.4-2003 Low-Rate Wireless Personal Area Network (WPAN) standard. The standard specifies its lower protocol layers—the physical layer (PHY), and the medium access control (MAC) portion of the data link layer (DLL). This standard specifies operation in the unlicensed 2.4 GHz, 915 MHz and 868 MHz ISM bands. In the 2.4 GHz band there are 16 ZigBee channels, with each channel requiring 5 MHz of bandwidth. The center frequency for each channel can be calculated as, FC=(2400+5*k) MHz, where k=1, 2, . . . 16.

The radios use direct-sequence spread spectrum coding, which is managed by the digital stream into the modulator. BPSK is used in the 868 and 915 MHz bands, and orthogonal QPSK that transmits two bits per symbol is used in the 2.4 GHz band. The raw, over-the-air data rate is 250 kbit/s per channel in the 2.4 GHz band, 40 kbit/s per channel in the 915 MHz band, and 20 kbit/s in the 868 MHz band. Transmission range is between 10 and 75 meters (33˜246 feet), although it is heavily dependent on the particular environment. The maximum output power of the radios is generally 0 dBm (1 mW).

The basic channel access mode specified by IEEE 802.15.4-2003 is “carrier sense, multiple access/collision avoidance” (CSMA/CA). That is, the nodes talk in the same way that people converse; they briefly check to see that no one is talking before they start. There are three notable exceptions to the use of CSMA. Beacons are sent on a fixed timing schedule, and do not use CSMA. Message acknowledgements also do not use CSMA. Finally, devices in Beacon Oriented networks that have low latency real-time requirements may also use Guaranteed Time Slots (GTS) which by definition do not use CSMA.

The system's sensor network capability offers added convenience and productivity. The system can include the ability to configure a mesh sensor network and other networks, typically referred as star or tree networks. The sensor network can permit the user to test and analyze multiple instruments with multi-node capture. This can also be applied to testing multiple sample blocks or reaction chambers within a single instrument.

Additionally, while the temperature monitoring system has been disclosed with particular reference to Zigbee wireless protocol, one skilled in the art would recognize that additional wireless protocols may be used, for example, Bluetooth, Wi-Fi, WiMax, or the like.

The wireless temperature monitoring system has been disclosed in detail in connection with various embodiments. These embodiments are disclosed by way of examples only and are not to limit the scope of the present invention, which is defined by the claims that follow. One of ordinary skill in the art will appreciate many variations and modifications within the scope of the present invention. The various embodiments of the system of the present invention may find use in many unique applications. Although thermal cycler temperature verification has been described herein, it is recognized that the system may be utilized for a variety of other temperature monitoring tests. Such additional tests may be thermally cycled or they may be carried out at a single temperature. The system may be utilized to perform temperature tests on general machines with moving mechanisms where sensors can be placed in different locations or travel freely with the machine under normal operating conditions.

What is claimed is:

1. A temperature monitoring system comprising:
a controller; and
a temperature monitoring device, wherein the temperature monitoring device includes a core comprising a processor and a wireless transmitter, and a cartridge comprising one or more temperature sensors, wherein the controller is configured to receive temperature data transmitted by the temperature monitoring device.

2. The temperature monitoring system according to claim 1, wherein the temperature monitoring device is configured to fit at least partially within a reaction chamber of a thermal cycler.

3. The temperature monitoring system according to claim 1, wherein the temperature monitoring device is configured to store a calibration algorithm.

4. The temperature monitoring system according to claim 2, wherein the core is configured to be compatible with a plurality of different cartridges, each of said different cartridges being compatible with one or more different thermal cycler instruments.

5. The temperature monitoring system according to claim 1, wherein the cartridge further comprises one or more replaceable sensor modules.

6. The temperature monitoring system according to claim 1, wherein the temperature monitoring device is configured to measure a temperature of a thermal environment within an initial calibration laboratory accuracy of plus or minus 0.005° C.

7. A temperature monitoring device, comprising
a temperature sensing element;
a radio frequency transmitter;
a battery; and
a controller, wherein the controller is in communication with the temperature sensing element and the radio frequency transmitter and is capable of running a self-calibration routine.

8. The temperature monitoring system according to claim 7, wherein the temperature monitoring device is configured to measure a temperature of a chemistry sample used in a thermal cycler.

9. The temperature monitoring system according to claim 8, wherein said temperature sensing element is embedded in a material having thermal characteristics similar to those of the chemistry sample.

10. The temperature monitoring system according to claim 8, wherein said temperature sensing element is suspended from a substrate and disposed so as to be capable of immersion into the chemistry sample, said chemistry sample being contained in a reaction plate.

11. A wireless sensor unit, comprising:
a frequency-hopping spread spectrum transceiver configured to transmit sensor data and to receive instructions;
at least one sensor configured to measure a signal indicative of temperature;
and a controller configured to control said transceiver and said at least one sensor, said wireless sensor unit configured to report data measured by said at least one sensor, said sensor unit configured to operate in a low-power mode when not transmitting data or receiving instructions, said sensor unit having an identification code and configured to implement instructions addressed to the sensor unit according to said identification code, and configured to receive said identification code during a reset interval.

12. The wireless sensor unit of claim 11 wherein said sensor unit is further configured to transmit status information at regular intervals and to enter a receive mode for a period after transmitting said status information.

13. The temperature monitoring system according to claim 11, wherein said sensor unit is configured to reduce a number of clock cycles during a conversion of an analog-to-digital unit.

14. A wireless sensor system, comprising:
one or more wireless sensor units, each of said one or more wireless sensor units comprising at least one sensor configured to measure a signal indicative of temperature, said wireless sensor unit configured to receive instructions;
said wireless sensor unit configured to report data measured by said at least one sensor, said one or more wireless sensor units operating in a low-power mode when not transmitting or receiving data, said one or more wireless sensors configured to transmit status information at regular intervals;
a base unit configured to communicate with said one or more wireless units and to provide data from said one or more sensor units to a monitoring computer, said monitoring computer configured to log data from one or more of said wireless sensor units.

15. The wireless sensor system according to claim 14, wherein the wireless sensor system is configured to measure a temperature in a reaction chamber of a thermal cycler.

16. A wireless sensor monitoring unit, comprising:
a base unit configured to communicate with one or more wireless sensor units and a monitoring computer, said monitoring computer configured to log data from one or more of said wireless sensor units, said base unit configured to send acknowledgements to acknowledge receipt of sensor data from said one or more wireless sensor units, each of said one or more wireless sensor units comprising at least one sensor configured to measure a signal indicative of temperature, said wireless sensor unit configured to receive instructions; said wireless sensor unit configured run self-diagnostic tests, said one or more wireless sensor units operating in a low-power mode when not transmitting or receiving data, said one or more wireless sensors configured to run said self-diagnostic tests and to transmit status information at regular intervals, said intervals programmed according to commands from said wireless sensor monitoring unit.

17. The wireless monitoring system according to claim 18, wherein one or more electronic components of the one or more wireless sensor units are disposed so as to remain outside of an immediate harsh thermal environment during operation.

18. The temperature monitoring system according to claim 19, wherein said one or more electronic components are disposed on a fixed substrate extending outside the immediate harsh thermal environment.

19. The temperature monitoring system according to claim 19, wherein said one or more electronic components are disposed within a protective sub-enclosure extended out of the immediate harsh thermal environment via a cable.

20. The temperature monitoring system according to claim 19, wherein said one or more electronic components are disposed on a perimeter of the wireless sensor unit.
